(19) United States
(12) Patent Application Publication
(10) Pub. No.: US 2023/0174387 A1
(43) Pub. Date: Jun. 8, 2023

(54) A METHOD, A SYSTEM, AND AN APPARATUS FOR PREPARING MANGANESE SULFATE

(71) Applicant: BEFESA ZINC METAL LLC, Mooresboro, NC (US)

(72) Inventors: Jacobus Rudolph de Wet, Greer, SC (US); William Joseph Cashwell, II, Marion, NC (US); Kendall Lee Oliphant, Rutherfordton, NC (US)

(21) Appl. No.: 17/997,876

(22) PCT Filed: May 3, 2021
(86) PCT No.: PCT/US2021/030408

§ 371 Date: Nov. 3, 2022

Related U.S. Application Data
(60) Provisional application No. 63/021,157, filed on May 7, 2020.

(51) Int. Cl. C01G 45/10; C25C 1/16

(52) U.S. Cl. CPC C01G 45/10; C25C 1/16

(57) ABSTRACT

A method, a system, and an apparatus for preparing manganese sulfate are provided. The method comprises introducing materials comprising a first stream, a second stream, and a reductant to a reactor to form a mixture. The first stream comprises a sulfate-containing acid, and the second stream comprises a manganese oxide compound. At least a portion of the mixture is reacted to provide a reactor outlet stream comprising an aqueous portion and an undissolved portion. The method comprises separating at least a portion of the aqueous portion from the undissolved portion in the reactor outlet stream to produce an aqueous stream comprising manganese sulfate and an undissolved stream.

### FIELD OF USE

The present disclosure relates to a method, a system, and an apparatus for preparing manganese sulfate.

### BACKGROUND

The successful production of Special High Grade zinc by zinc electrowinning from zinc sulfate solutions can be dependent on limiting the co-plating of impurities, such as, for example, lead, copper, cadmium, and cobalt. Lead contamination of the zinc cathodes can arise from corrosion of lead/silver anodes, which can be mitigated by the passivation of the lead/silver anodes’ surfaces with manganese dioxide. The manganese dioxide can be formed through the oxidation of manganese sulfate on the lead/silver anodes’ surfaces at normal operating conditions. Conventional zinc concentrates typically contain naturally occurring manganese sulfide, which is converted to manganese oxide and ultimately manganese sulfate in the upstream roast-leach purification process, which can yield sufficiently high manganese sulfate levels in the zinc sulfate electrolyte to achieve passivation of the lead/silver anodes without the requirement to add manganese sulfate, oxide, or metal as a reagent.

The introduction of zinc solvent extraction processes to the zinc industry has facilitated the treatment of complex ores and secondary materials, which cannot be treated through the conventional roast-leach purification process. For example, a zinc solvent extraction process, such as, the Modified Zincex® Process (MZP), incorporates atmospheric leaching, impurity precipitation through pH control and solvent extraction, using a mixture of di-2-ethyl-hexyl-phosphoric acid extractant and a kerosene-based diluent. There are challenges with providing a manganese sulfate source in a zinc solvent extraction process.

### SUMMARY

In one aspect according to the present disclosure, a method for preparing manganese sulfate is provided. The method comprises introducing materials comprising a first stream, a second stream, and a reductant to a reactor to form a mixture. The first stream comprises a sulfate-containing acid, and the second stream comprises a manganese oxide (e.g., one or more of MnO, MnO₂, MnO₃, Mn₂O₃, Mn₂O₇, and Mn₃O₄) compound. At least a portion of the mixture is reacted to provide a reactor outlet stream comprising an aqueous portion and an undissolved portion. The method further comprises separating at least a portion of the aqueous portion from the undissolved portion in the reactor outlet stream to produce an aqueous stream comprising manganese sulfate and an undissolved stream.

In another aspect according to the present disclosure, a system for recycling manganese from a zinc electrowinning process is provided. The system comprises a leaching reactor and a separator. The leaching reactor comprises an inlet and an outlet. The inlet is configured to receive an electrolyte stream, a feed stream, and a reductant. The leaching reactor is configured to form a mixture from the electrolyte stream, the feed stream, and the reductant. The electrolyte stream comprises a sulfate-containing acid, and the feed stream comprises a manganese oxide compound. The outlet is configured to pass a reactor outlet stream comprising an aqueous portion and an undissolved portion from the leaching reactor. The leaching reactor is configured to react at least a portion of the mixture to form the reactor outlet stream. The separator is in fluid communication with the outlet of the leaching reactor to receive the reactor outlet stream. The separator is configured to separate at least a portion of the aqueous portion from the undissolved portion in the reactor outlet stream to produce an aqueous stream comprising manganese sulfate and an undissolved stream.

In yet another aspect according to the present disclosure, a zinc electrowinning system is provided that comprises a system for recycling manganese from a zinc electrowinning process. An electrolyte stream and a feed stream are produced from the zinc electrowinning process. The system for recycling manganese comprises a leaching reactor and a separator. The leaching reactor comprises an inlet and an outlet. The inlet is configured to receive an electrolyte stream, a feed stream, and a reductant. The leaching reactor is configured to form a mixture from the electrolyte stream, the feed stream, and the reductant. The electrolyte stream comprises a sulfate-containing acid, and the feed stream comprises a manganese oxide compound. The outlet is configured to pass a reactor outlet stream comprising an aqueous portion and an undissolved portion from the leaching reactor. The leaching reactor is also configured to react at least a portion of the mixture to form the reactor outlet stream. The separator is in fluid communication with the outlet of the leaching reactor to receive the reactor outlet stream. The separator is configured to separate at least a portion of the aqueous portion from the undissolved portion in the reactor outlet stream to produce an aqueous stream comprising manganese sulfate and an undissolved stream.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a flow chart illustrating a non-limiting embodiment of a method for preparing manganese sulfate according to the present disclosure;

FIG. 2 is a schematic diagram of a non-limiting embodiment of a system for preparing manganese sulfate according to the present disclosure; and

FIG. 3 is a schematic diagram of a non-limiting embodiment of a system comprising at least two leaching reactors for preparing manganese sulfate according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed methods, apparatus, and systems. The various examples described and illustrated herein are non-limiting and non-exhaustive. Thus, an invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

Unless otherwise specified, all pressure values provided herein are absolute pressure values.

The present inventors discovered that during a zinc solvent extraction process, such as, for example, MZP, a barrier against the transfer of manganese sulfate from the leach circuit to the zinc sulfate electrolyte solution can require the zinc solvent extraction process to include the addition of high-purity manganese sulfate, oxide, or metal to achieve effective passivation of the lead/silver anodes through the formation of manganese oxide on the surface of the anodes.

The addition of manganese metal to a zinc solvent extraction process can require special handling procedures due to the evolution of hydrogen gas. Additionally, conventional high-purity manganese sources can be expensive. Thus, the present disclosure provides a method, a system, and an apparatus for preparing manganese sulfate that can be used in the passivation of anodes in a zinc electrowinning process. In various non-limiting embodiments, the manganese sulfate prepared according to the present disclosure may reduce and/or eliminate the need for the addition of manganese metal to the zinc electrowinning process. In certain non-limiting embodiments, the method, system, and apparatus according to the present disclosure can reduce operating cost by recycling materials (e.g., spent electrolyte, manganese oxide) from the zinc electrowinning process. In some non-limiting embodiments, the manganese oxide can be recycled from anode sludge produced by a conventional zinc electrowinning process.

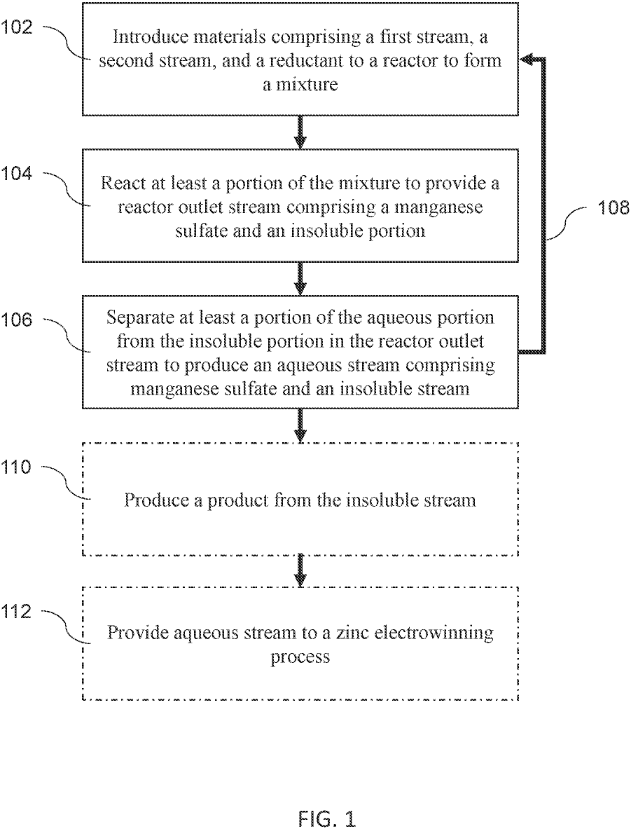

FIG. 1 provides a flow chart illustrating a non-limiting embodiment of a method for preparing manganese sulfate according to the present disclosure. The method comprises introducing materials comprising a first stream, a second stream, and a reductant to a reactor to form a mixture, 102. In various non-limiting embodiments, the first stream comprises electrolyte from a zinc electrowinning process that can produce zinc or a zinc alloy. In certain non-limiting embodiments, the second stream comprises anode sludge produced by a zinc electrowinning process.

The first stream comprises a sulfate-containing acid. In various non-limiting embodiments the sulfate-containing stream comprises sulfuric acid. The first stream can additionally comprise at least one of zinc sulfate, manganese sulfate, and minor impurities. In certain non-limiting embodiments, the first stream can comprise sulfuric acid; optionally, at least one of zinc sulfate, manganese sulfate, and minor impurities; and a balance of water.

The second stream comprises a manganese oxide compound. In various non-limiting embodiments the manganese oxide compound comprises one or more of MnO, MnO₂, MnO₃, Mn₂O₃, Mn₂O₇, and Mn₃O₄. In various non-limiting embodiments, the manganese oxide compound comprises MnO₂. The second stream can additionally comprise at least one of a lead compound (e.g., lead sulfate), a calcium compound (e.g., calcium sulfate), a silver compound (e.g., metallic silver), a copper compound, a cadmium compound, and minor impurities. In certain non-limiting embodiments, the second stream can comprise MnO2; optionally, at least one of a lead compound, a calcium compound, a silver compound, a copper compound, a cadmium compound, and minor impurities; and a balance of water.

The reductant can comprise at least one of hydrogen peroxide and sulfur dioxide. In various embodiments, the reductant can be introduced into the reactor in an amount so that a stoichiometric ratio between the reductant and the manganese oxide is at least a minimum value. For example, in certain non-limiting embodiments, the reductant can be introduced into the reactor in an amount so that a stoichiometric ratio between the reductant and the manganese oxide is at least 1 mole reductant to 1 mole manganese oxide. The addition of reductant can reduce the oxidation state of the manganese present in the reactor, such as, for example, from Manganese (IV) to Manganese (II) (e.g., manganese oxide to manganese sulfate).

The method comprises reacting at least a portion of the mixture to provide a reactor outlet stream comprising an aqueous portion comprising manganese sulfate and an undissolved portion, 104. For example, in embodiments where the reductant comprises hydrogen peroxide and the manganese oxide compound comprises MnO₂, the reaction may proceed according to Reaction 1 below.

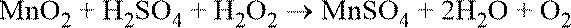

In various non-limiting embodiments, the oxygen gas produced from reacting can be removed from the reactor. Additionally, the mixture can be stirred during the reacting in order to keep undissolved particulate (e.g., manganese oxide) suspended in the mixture and/or facilitate the reacting.

The method comprises separating at least a portion of the aqueous portion from the undissolved portion in the reactor outlet stream to produce an aqueous stream comprising manganese sulfate and an undissolved stream (e.g., filter cake), 106. The undissolved stream can comprise for example, at least one of non-reacted manganese oxide, a lead compound, a calcium compound, a silver compound, a copper compound, a cadmium compound, minor impurities, and residual moisture. The aqueous stream can comprise, for example, manganese sulfate, water, and minor impurities.

Separating at least a portion of the aqueous portion from the undissolved portion in the reactor outlet stream can comprise a solid/liquid separation process, such as, for example, at least one of adding a thickener to the reactor outlet stream and clarifying the reactor outlet stream, processing at least a portion of the reactor outlet stream with a vacuum belt filtration device, and/or processing at least a portion of the reactor outlet stream with a plate and frame filter press. The selection of the solid/liquid separation process can be dependent upon the composition of the first stream, the second stream, and the reductant, the desired clarity of a resulting aqueous stream, and/or a desired moisture content of the resulting undissolved stream. In various non-limiting embodiments, a flocculant and/or a coagulant can be added to the reactor outlet stream to facilitate precipitation of an undissolved portion.

In various non-limiting embodiments, at least a portion of the aqueous stream can be recycled to the reactor, 108. Recycling the aqueous stream can improve the clarity of the mixture in the reactor.

In various non-limiting embodiments, at least a portion of the undissolved stream can be smelted or hydrometallurgically leached to produce a product, 110. For example, in embodiments where the first stream comprises spent anode sludge, the downstream processing of the undissolved stream can comprise lead and/or silver recovery utilizing smelting or hydrometallurgical leaching, precipitation, and purification.

In various non-limiting embodiments, at least a portion of the aqueous stream can be used in a zinc electrowinning process, 112. For example, the aqueous stream can be used as the manganese sulfate source for passivation of electrodes in the zinc electrowinning process. In various non-limiting embodiments, zinc or a zinc alloy can be produced utilizing the zinc electrowinning process and the aqueous stream. In certain non-limiting embodiments, the method according to FIG. 1 can be operated as a batch process or a continuous process depending on the desired application.

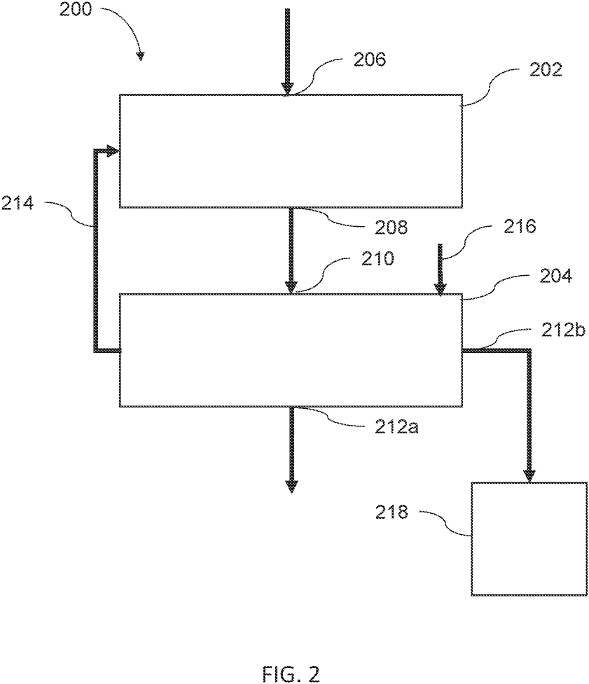

Referring to FIG. 2, a system 200 for recycling manganese from a zinc electrowinning process is provided. The system 200 comprises a leaching reactor 202 and a separator 204 (e.g., solid/liquid separator). The leaching reactor 202 can comprise an inlet 206 and an outlet 208.

The inlet 206 can be configured to receive a first stream (e.g., an electrolyte stream), a second stream (e.g., a manganese feed stream), and a reductant. The inlet 206 can be configured as a single inlet or multiple inlets. For example, in various non-limiting embodiments, the inlet 206 can be configured to include separate ports of the inlet 206 for each of the first stream, the second stream, and the reductant. In certain non-limiting embodiments, at least two of the first stream, the second stream, and the reductant can be combined to pass into a single port of the inlet 206 prior to being introduced into the leaching reactor 202. Regardless of the number of ports comprising the inlet 206, the inlet 206 can receive and transport the first stream, the second stream, and the reductant into the leaching reactor 202.

The leaching reactor 202 can be configured to combine the electrolyte stream, the feed stream, and the reductant together and form a mixture therefrom. The leaching reactor 202 can be configured to react at least a portion of the mixture to form a reactor outlet stream comprising an aqueous portion comprising manganese sulfate and an undissolved portion. In certain non-limiting embodiments, the leaching reactor 202 can be configured as a continuously stirred tank reactor such that the first stream, the second stream, and the reductant can be mixed to form the mixture and can ensure that undissolved particulate, such as, for example, an undissolved manganese compound, is suspended within the mixture.

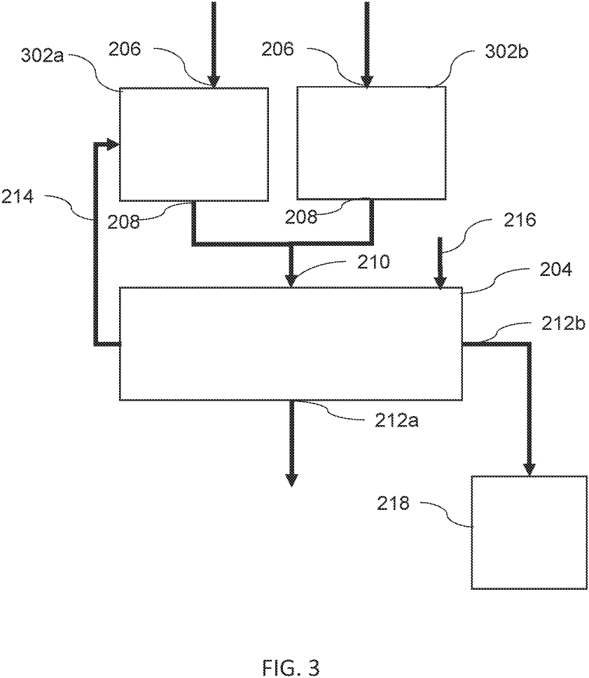

The leaching reactor 202 can be operated as a batch reactor or a continuous reactor depending on a desired application. In various non-limiting embodiments where the flow rate of the first stream and/or the second stream is low, it may be desirable to operate the leaching reactor 202 as a batch reactor. For example, it may be desirable to allow the first stream and second stream to flow into the leaching reactor 202 over a period of time and only operate the leaching reactor 202 when a desired amount of the first stream and the second stream has been received, which can reduce costs associated with continuous operation. In various non-limiting embodiments, referring to FIG. 3, at least two batch reactors 302a-b can be provided and reacting the mixture can be selectively performed in the at least two batch reactors 302a-b. For example, it may be desirable to maintain a continuous flow of the reactor outlet stream to downstream processes such as, for example, the separator 204, even though the formation of the reactor outlet stream occurs as a batch process. By providing at least two batch reactors 302a-b, a reactor outlet stream can be provided from batch reactor 302a to the separator 204 while the second batch reactor 302b is reacting the mixture, receiving the first stream and second stream, or is otherwise in a state unable to supply a reactor outlet stream to the separator 204.

Referring again to FIG. 2, the outlet 208 of the leaching reactor 202 can be configured to receive the reactor outlet stream and transport the reactor outlet stream out of the leaching reactor 202.

The separator 204 can comprise an inlet 210 and outlets 212a-b. The inlet 210 can be in fluid communication with the outlet 208 of the leaching reactor 202 and configured to receive the reactor outlet stream and transport the reactor outlet stream into the separator 204. In various non-limiting embodiments, the separator 204 can comprise an additional inlet 216 suitable to receive a thickener, a flocculant, and/or a coagulant.

The separator 204 can be configured to separate at least a portion of the aqueous portion from the undissolved portion in the reactor outlet stream to produce an aqueous stream comprising manganese sulfate, and an undissolved stream. In various non-limiting embodiments, the separator 204 can comprise at least one of a clarification vessel, a vacuum belt filtration device, and a plate and frame filter press.

The system 200 can comprise a recycle line 214 in fluid communication with the separator 204 and the leaching reactor 202. The recycle line 214 can be configured to transport at least a portion of the aqueous stream to the leaching reactor 202. Adding at least a portion of the aqueous stream to the leaching reactor 202 can enable removal of suspended solids within the leaching reactor 202 and thereby improve the clarity of the aqueous stream. In various non-limiting embodiments, the recycle line 214 is only used to transport at least a portion of the aqueous stream to the leaching reactor 202 during startup of the system 200.

The outlet 212b can be configured to receive the aqueous stream and transport the aqueous stream out of the separator 204. In various non-limiting embodiments, the system 200 can comprise a zinc electrowinning system 218. The outlet 212b can be in fluid communication with the zinc electrowinning system 218 (e.g., cell house of the zinc electrowinning system 218) and can introduce the aqueous stream to the zinc electrowinning system 218. The zinc electrowinning system 218 can be configured to produce zinc or a zinc alloy utilizing the aqueous stream. In various non-limiting embodiments, the first stream and the second stream can be produced by the zinc electrowinning system 218, and the zinc electrowinning system 218 can be in fluid communication with the leaching reactor 202 (not shown).

The outlet 212a can be configured to receive the undissolved stream and transport the undissolved stream out of the separator 204. In various non-limiting embodiments, the system 200 can comprise a smelter or a hydrometallurgical leaching apparatus (not shown) configured to transform the undissolved stream into a product.

In various non-limiting embodiments, the system 200 can process up to 200 kg/hour of manganese oxide.

### ASPECTS OF THE INVENTION

Various aspects of the invention include, but are not limited to, the aspects listed in the following numbered clauses

1. A method for preparing manganese sulfate, the method comprising:
introducing materials comprising a first stream, a second stream, and a reductant to a reactor to form a mixture, wherein the first stream comprises a sulfate-containing acid, and wherein the second stream comprises a manganese oxide compound;
reacting at least a portion of the mixture to provide a reactor outlet stream comprising an aqueous portion and an undissolved portion; and
separating at least a portion of the aqueous portion from the undissolved portion in the reactor outlet stream to produce an aqueous stream comprising manganese sulfate and an undissolved stream.

2. The method of clause 1, wherein the first stream comprises electrolyte from a zinc electrowinning process.

3. The method of clause 2, wherein the zinc electrowinning process produces zinc or zinc alloy.

4. The method of any one of clauses 2-3, wherein the first stream further comprises at least one of zinc sulfate and manganese sulfate.

5. The method of any one of clauses 2-4, wherein the sulfate-containing acid comprises sulfuric acid.

6. The method of any one of clauses 2-5, wherein the manganese oxide compound comprises at least one of MnO, MnO₂, MnO₃, Mn₂O₃, Mn₂O₇, and Mn₃O₄.

7. The method of any one of clauses 2-6, wherein the manganese oxide compound comprises MnO₂.

8. The method of any one of clauses 2-7, wherein the second stream further comprises at least one of a lead compound, a calcium compound, a silver compound, a copper compound, and a cadmium compound.

9. The method of any one of clauses 2-8, wherein the reductant comprises at least one of hydrogen peroxide and sulfur dioxide.

10. The method of any one of clauses 2-9, wherein the reactor is a continuously stirred tank reactor.

11. The method of any one of clauses 2-10, wherein reacting at least a portion of the mixture to provide the reactor outlet stream is performed as a batch process.

12. The method of clause 11, wherein reacting at least a portion of the mixture to provide the reactor output stream is selectively performed in at least two different batch reactors.

13. The method of any one of clauses 2-10, wherein reacting at least a portion of the mixture to provide the reactor output stream is performed as a continuous process.

14. The method of any one of clauses 2-13, wherein separating at least a portion of the aqueous portion from the undissolved portion in the reactor outlet stream comprises at least one of adding a thickener and clarifying the reactor outlet stream, processing the reactor outlet stream to a vacuum belt filtration device, and processing the reactor outlet stream to a plate and frame filter press.

15. The method of any one of clauses 2-14, further comprising adding at least one of a flocculant and a coagulant to the reactor outlet stream.

16. The method of any one of clauses 2-15, wherein the reductant is introduced into the reactor at a molar ratio of at least 1 mole reductant to 1 mole manganese oxide.

17. The method of any one of clauses 2-16, further comprising smelting or hydrometallurgical leaching at least a portion of the undissolved stream to produce a product.

18. The method of any one of clauses 2-17, further comprising recycling at least a portion of the aqueous stream to the reactor.

19. The method of any one of clauses 2-18, wherein the first stream and the second stream are produced in the zinc electrowinning process.

20. The method of any one of clauses 2-19, further comprising producing zinc or a zinc alloy utilizing the zinc electrowinning process and wherein the first stream and the second stream are produced from the zinc electrowinning process.

21. The method of clause 20, further comprising producing zinc or a zinc alloy utilizing the aqueous stream in the zinc electrowinning process.

22. A system for recycling manganese from a zinc electrowinning process, the system comprising:
a leaching reactor comprising
   an inlet configured to receive an electrolyte stream, a feed stream, and a reductant,
   wherein the leaching reactor is configured to form a mixture from the electrolyte stream, the feed stream, and the reductant, wherein the electrolyte stream comprises a sulfate-containing acid, and wherein the feed stream comprises a manganese oxide compound, and
   an outlet configured to pass a reactor outlet stream comprising an aqueous portion and an undissolved portion, wherein the leaching reactor is configured to react at least a portion of the mixture to form the reactor outlet stream; and
a separator in fluid communication with the outlet of the leaching reactor to receive the reactor outlet stream, the separator configured to separate at least a portion of the aqueous portion from the undissolved portion in the reactor outlet stream to produce an aqueous stream comprising manganese sulfate and an undissolved stream.

23. The system of clause 22, wherein the leaching reactor is a continuously stirred tank reactor.

24. The system of any one of clauses 22-23, wherein the leaching reactor is a batch reactor.

25. The system of any one of clauses 22-23, wherein the leaching reactor is a continuous reactor.

26. The system of any one of clauses 22-25, wherein the separator comprises at least one of a clarification vessel, a vacuum belt filtration device, and a plate and frame filter press.

27. The system of any one of clauses 22-26, further comprising a recycle line in fluid communication with the separator and the leaching reactor, wherein the recycle line is configured to transport at least a portion of the aqueous stream to the reactor to facilitate removal of suspended solids in the leaching reactor.

28. A zinc electrowinning system comprising the system of any one of clauses 22-27, wherein the electrolyte stream and feed stream are produced from the zinc electrowinning process.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A method for preparing manganese sulfate, the method comprising:
introducing materials comprising a first stream, a second stream, and a reductant to a reactor to form a mixture, wherein the first stream comprises a sulfate-containing acid, and wherein the second stream comprises a manganese oxide compound;
reacting at least a portion of the mixture to provide a reactor outlet stream comprising an aqueous portion and an undissolved portion; and
separating at least a portion of the aqueous portion from the undissolved portion in the reactor outlet stream to produce an aqueous stream comprising manganese sulfate and an undissolved stream.

2. The method of claim 1, wherein the first stream comprises electrolyte from a zinc electrowinning process.

3. The method of claim 2, wherein the zinc electrowinning process produces zinc or zinc alloy.

4. The method of claim 2, wherein the first stream further comprises at least one of zinc sulfate and manganese sulfate.

5. The method of claim 2, wherein the sulfate-containing acid comprises sulfuric acid.

6. The method of claim 2, wherein the manganese oxide compound comprises at least one of MnO, MnCh, MnO₃, Mn₂O₃, Mn₂O₇, and Mn₃O₄.

7. The method of claim 2, wherein the manganese oxide compound comprises MnO₂.

8. The method of claim 2, wherein the second stream further comprises at least one of a lead compound, a calcium compound, a silver compound, a copper compound, and a cadmium compound.

9. The method of claim 2, wherein the reductant comprises at least one of hydrogen peroxide and sulfur dioxide.

10. The method of claim 2, wherein the reactor is a continuously stirred tank reactor.

11. The method of claim 2, wherein reacting at least a portion of the mixture to provide the reactor outlet stream is performed as a batch process.

12. The method of claim 11, wherein reacting at least a portion of the mixture to provide the reactor output stream is selectively performed in at least two different batch reactors.

13. The method of claim 2, wherein reacting at least a portion of the mixture to provide the reactor output stream is performed as a continuous process.

14. The method of claim 2, wherein separating at least a portion of the aqueous portion from the undissolved portion in the reactor outlet stream comprises at least one of adding a thickener and clarifying the reactor outlet stream, processing the reactor outlet stream to a vacuum belt filtration device, and processing the reactor outlet stream to a plate and frame filter press.

15. The method of claim 2, further comprising adding at least one of a flocculant and a coagulant to the reactor outlet stream.

16. The method of claim 2, wherein the reductant is introduced into the reactor at a molar ratio of at least 1 mole reductant to 1 mole manganese oxide.

17. The method of claim 2, further comprising smelting or hydrometallurgical leaching at least a portion of the undissolved stream to produce a product.

18. The method of claim 2, further comprising recycling at least a portion of the aqueous stream to the reactor.

19. The method of claim 2, wherein the first stream and the second stream are produced in the zinc electrowinning process.

20. The method of claim 2, further comprising producing zinc or a zinc alloy utilizing the zinc electrowinning process and wherein the first stream and the second stream are produced from the zinc electrowinning process.

21. The method of claim 20, further comprising producing zinc or a zinc alloy utilizing the aqueous stream in the zinc electrowinning process.

22. A system for recycling manganese from a zinc electrowinning process, the system comprising:
a leaching reactor comprising
an inlet configured to receive an electrolyte stream, a feed stream, and a reductant,
wherein the leaching reactor is configured to form a mixture from the electrolyte stream, the feed stream, and the reductant, wherein the electrolyte stream comprises a sulfate-containing acid, and wherein the feed stream comprises a manganese oxide compound, and
an outlet configured to pass a reactor outlet stream comprising an aqueous portion and an undissolved portion, wherein the leaching reactor is configured to react at least a portion of the mixture to form the reactor outlet stream; and
a separator in fluid communication with the outlet of the leaching reactor to receive the reactor outlet stream, the separator configured to separate at least a portion of the aqueous portion from the undissolved portion in the reactor outlet stream to produce an aqueous stream comprising manganese sulfate and an undissolved stream.

23. The system of claim 22, wherein the leaching reactor is a continuously stirred tank reactor.

24. The system of claim 22, wherein the leaching reactor is a batch reactor.

25. The system of claim 22, wherein the leaching reactor is a continuous reactor.

26. The system of claim 22, wherein the separator comprises at least one of a clarification vessel, a vacuum belt filtration device, and a plate and frame filter press.

27. The system of claim 22, further comprising a recycle line in fluid communication with the separator and the leaching reactor, wherein the recycle line is configured to transport at least a portion of the aqueous stream to the reactor to facilitate removal of suspended solids in the leaching reactor.

28. A zinc electrowinning system comprising the system of claim 22, wherein the electrolyte stream and feed stream are produced from the zinc electrowinning process.
